(19) United States
(12) Patent Application Publication
(10) Pub. No.: US 2008/0025474 A1
(43) Pub. Date: Jan. 31, 2008

(54) Method for operating a diagnostic apparatus with an x-ray system and a position determination system for catheters together with diagnostic apparatus for performance of the method

(76) Inventors: Anton Nekovar, Neunkirchen (DE); Bernhard Sandkamp, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/880,146

(22) Filed: Jul. 20, 2007

(30) Foreign Application Priority Data
Jul. 21, 2006 (DE) 10 2006 033 884.7

(51) Int. Cl. G01D 18/00

(52) U.S. Cl. 378/207

(57) ABSTRACT

The invention relates to a method for operating a diagnostic apparatus with an x-ray system for generating x-ray images, which has an x-ray device and an image system for the x-ray device, with a system for determining the position of objects, for example a measurement catheter, and a control facility for at least the x-ray system, whereby after an x-ray pulse a first read-out containing useful information is saved as an x-ray image, immediately afterwards a second read-out not containing useful information is saved as an interference image, and the x-ray image is corrected for the purpose of minimizing interference. Such diagnostic apparatuses are used in various medical procedures, for example in PCI (Percutaneous coronary intervention) and cardiac EP (electrophysiology) interventions.

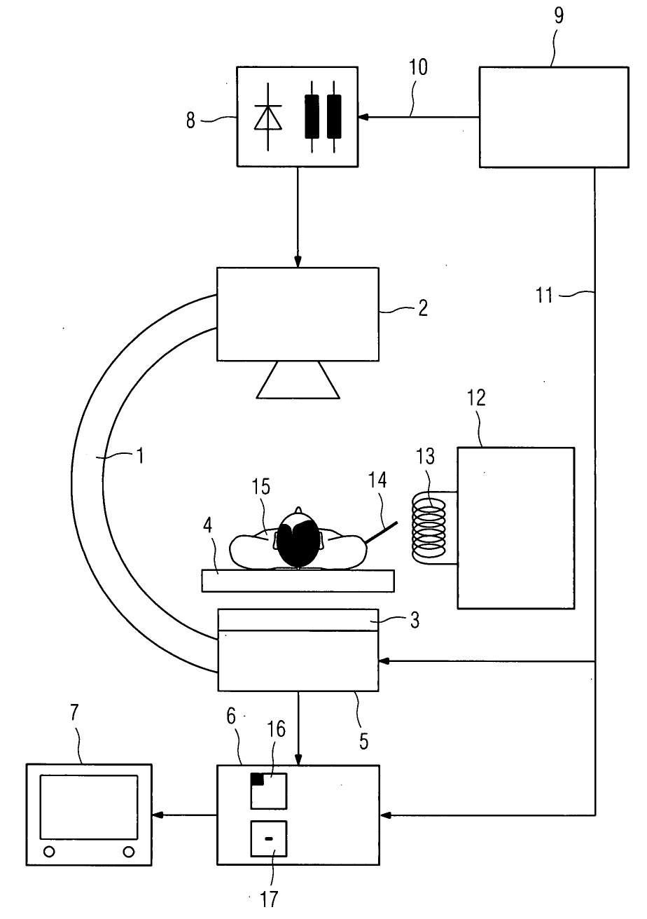

### CROSS REFERENCE TO RELATED APPLICATIONS

This application claims priority of German application No. 10 2006 033 884.7 filed Jul. 21, 2006, which is incorporated by reference herein in its entirety.

### FIELD OF THE INVENTION

The invention relates to a method for operating a diagnostic apparatus with an x-ray system for generating x-ray images, said apparatus having an x-ray device and an image system for the x-ray device, with a system for determining the position of objects, for example a measurement catheter, and a control facility for at least the x-ray system, whereby in the case of position determination systems the object is used to measure the amplitudes of different magnetic fields and to determine the positions of the measurement catheter therefrom. Such diagnostic apparatuses are used in various medical procedures, for example in PCI (percutaneous coronary intervention) and cardiac EP (electrophysiology) interventions.

### BACKGROUND OF THE INVENTION

U.S. Pat. No. 5,757,884 A discloses an x-ray system referred to above with a flat image transducer which has a scintillator layer and a semiconductor layer with pixel elements arranged in a matrix. These flat image detectors have only recently been launched on the market.

In the field of medical engineering there are catheter position determination systems that work with magnetic or electromagnetic fields. U.S. Pat. No. 5,752,513 A describes such a magnetic position determination system for catheters. These position determination systems result in image interference in the case of flat image detectors, as used ever more frequently in x-ray technology, because of their strong magnetic fields. This interference can for example be horizontal stripes in the image, which are superimposed as an additive component on the actual image information.

In the past image transducers were primarily image intensifiers linked to CCD cameras. These image intensifiers and the CCD cameras are not affected by the fields radiated by the position determination system. Hence this problem was not identified previously. However, in the case of new x-ray diagnostic systems flat image detectors are now used almost exclusively.

U.S. Pat. No. 5,265,610 A discloses a diagnostic apparatus with an x-ray system for generating x-ray images which has an x-ray device with an x-ray image detector and an image system for the x-ray device, and with a system for determining the position of objects.

The older patent application DE 10 2005 014 286.9 describes a method in which the systems are synchronized such that permanent interference and interference can be corrected by image processing occurs. However, it is also known for both systems to be aligned to one another such that the position determination system is deactivated while the x-ray system is in operation.

### SUMMARY OF THE INVENTION

The object of the invention is to develop a method and a diagnostic apparatus of the type referred to in the introduction, such that the image interference can be significantly reduced or completely eliminated in a simple manner.

The object is inventively achieved for a method as claimed in the claims, in that after an x-ray pulse a first read-out containing useful information is saved as an x-ray image, that immediately afterwards a second read-out not containing useful information is saved as an interference image, and that the x-ray image is corrected for the purpose of minimizing interference. This correction allows image artifacts that occur when using catheter position determination systems in combination with x-ray systems to be almost totally eliminated.

Advantageous embodiments are the subject matter of the subclaims.

The two-read-outs have the minimum time interval between them if they are performed line by line, i.e. after a line is read out a first time it is immediately read out a second time, before the first read-out of the next line takes place.

It has proved advantageous if the information in the second read-out is subtracted from the information in the first read-out.

The object is inventively achieved for a diagnostic apparatus for performing the method as claimed in the claims in that the image system has a correction facility, and in that the control facility and the correction facility are designed such that the correction facility effects a correction of the x-ray image on the basis of the two read-outs.

Advantageously, the correction facility as claimed in the claims can have an image memory for an x-ray image and an interference image linked to a subtraction layer.

### BRIEF DESCRIPTION OF THE DRAWINGS

The invention is described below on the basis of an exemplary embodiment illustrated in the drawing showing a diagnostic apparatus with x-ray system and position determination system.

### DETAILED DESCRIPTION OF THE INVENTION

The figure shows a diagnostic apparatus with x-ray system and position determination system which has a C arm 1, to which an x-ray source 2 and a flat image detector 3 are attached. This x-ray diagnostic apparatus enables a patient 15 lying on a patient table 4 between x-ray source 2 and flat image detector 3 to be penetrated by x-rays. The x-rays attenuated by the patient 15 are detected by the flat image detector 3.

The support for the C arm 1 of the x-ray diagnostic apparatus is not shown. Any known support can be used which is mounted either on the floor or on the ceiling. In place of the C arm 1, robot arms can also be used which hold the x-ray source 2 and the flat image detector 3 directly and are electronically coupled such that they form what is known as an electronic C arm.

A read-out electronic system 5 known per se is assigned to the flat image detector 3, and reads out the image data. This data is supplied to an x-ray image system 6 which converts the data into an image which is displayed on a monitor 7.

A high-voltage generator 8 is connected to the x-ray source 2 and is operated by a control facility 9 via a control cable 10. The control facility 9 is connected to the read-out electronic system 5 for the flat image detector 3 and to the image system 6 via a control cable 11.

The diagnostic apparatus further has a magnetic position determination system 12 for example for an object, for example a catheter 14 or a stent, which generates a magnetic field by means of coils 13. The catheter 14 is used to measure the amplitudes of the different magnetic fields and from these to determine the position of the catheter 14 and/or to track it. The magnetic position determination system 12 can have its own separate display facility, not shown here.

According to the invention, the x-ray image system 6 has an image memory 17 and a subtraction level 18 as a correction facility in order to correct x-ray images affected by interference.

The interference in the x-ray image induced by the magnetic position determination system 12 is visible as horizontal stripes, since the flat image detector reads out line by line. It is the case here that the interferences emitted by the position determination system 12 is in the frequency range of a few kHz.

The idea on which the present patent application is based is that the interference occurring in the read-out process and its effect on the flat image detector 3 have in practice not changed if the information from the flat image detector 3 is read out very quickly twice in succession, no x-ray radiation being applied during the read-outs. Especially short time intervals occur if in each case one line is read out after the other. This fast, line-by-line read-out can take place at intervals of a few μs.

Image signal and interference are read out during the first read-out. The result is that the actual x-ray image information is deleted from this line, since the control facility 9 is designed such that no x-ray radiation is generated during the read-out process. Hence during the second read-out x-ray image information is no longer present, but the interference is still there since it is not injected until the read-out process itself. By subtracting the interference image of the second read-out saved in the image memory 17 of the correction level from the x-ray image of the first read-out likewise saved in the image memory 17 of the correction level by means of the subtraction level 18, correction of the interference is obtained.

The advantage is that the x-ray system 1 to 11 and the position determination system 12 for catheters 14 can be operated simultaneously without affecting one another—an absolute requirement in the clinical procedure.

It is also possible to operate modern flat image detector technology in conjunction with position determination systems 12 for catheters 14. Thus it is not necessary to switch to image intensifier systems which will soon no longer be available. In comparison to other methods it is also no longer necessary to align the systems with one another.

1-5. (canceled)

6. A method for operating a diagnostic apparatus having an x-ray system, comprising:
performing a first read-out comprising an image signal and an interference signal after an x-ray pulse;
immediately performing a second read-out comprising the interference signal after the first read-out; and
correcting the interference signal based on the first and the second read-outs.

7. The method as claimed in claim 6, wherein the first and the second read-outs are performed along a line.

8. The method as claimed in claim 7, wherein the line is read out twice by the first and the second read-outs before a further first read-out for a further line.

9. The method as claimed in claim 6, wherein the first read-out is saved as an x-ray image.

10. The method as claimed in claim 9, wherein the second read-out is saved as an interference image.

11. The method as claimed in claim 10, wherein the x-ray image is corrected by subtracting the interference image from the x-ray image.

12. The method as claimed in claim 6, wherein the diagnostic apparatus further comprises a position determination system.

13. The method as claimed in claim 12, wherein the position determination system is a magnetic position determination system for determining a position of a catheter or a stent.

14. The method as claimed in claim 12, wherein the interference signal is caused by the position determination system.

15. A diagnostic apparatus for performing a medical diagnosis for a patient, comprising:
an x-ray source that generates an x-ray pulse;
an x-ray detector that:
reads out a first read-out comprising an image signal of the patient and an interference signal after the x-ray pulse,
immediately reads out a second read-out comprising the interference signal after the first read-out; and
a correction device that corrects the interference signal based on the first and the second read-outs.

16. The diagnostic apparatus as claimed in claim 15, wherein the first and the second read-outs are read out along a line.

17. The diagnostic apparatus as claimed in claim 16, wherein the line is read out twice by the first and the second read-outs before a further first read-out for a further line.

18. The diagnostic apparatus as claimed in claim 15, wherein the first read-out is saved as an x-ray image.

19. The diagnostic apparatus as claimed in claim 18, wherein the second read-out is saved as an interference image.

20. The diagnostic apparatus as claimed in claim 19, wherein the x-ray image is corrected by subtracting the interference image from the x-ray image.

21. The diagnostic apparatus as claimed in claim 20, wherein the correction device comprises an image memory for saving the x-ray image and the interference image.

22. The diagnostic apparatus as claimed in claim 15, wherein the diagnostic apparatus further comprises a position determination system.

23. The diagnostic apparatus as claimed in claim 22, wherein the position determination system is a magnetic position determination system for determining a position of a catheter or a stent.

24. The diagnostic apparatus as claimed in claim 23, wherein the interference signal is caused by the position determination system.
